(19) United States
(12) Patent Application Publication
(10) Pub. No.: US 2020/0282243 A1
(43) Pub. Date: Sep. 10, 2020

(54) Advanced Multi-Threat Base Ensemble for Emergency Responders

(71) Applicant: North Carolina State University, Raleigh, NC (US)

(72) Inventors: Francisco Javier Martinez, Boston, MA (US); Bettina Marie Pasquantonio, Wrentham, MA (US); Marc Christopher Mathews, Raleigh, NC (US); Cassandra H. Kwon, Raleigh, NC (US); Matthew E. Kent, Raleigh, NC (US); Roger Lee Barker, Raleigh, NC (US); Emiel A. Den Hartog, Raleigh, NC (US); Donald B. Thompson, Raleigh, NC (US); Susan Courtney English, Wellesley, MA (US)

(21) Appl. No.: 16/810,698

(22) Filed: Mar. 5, 2020

Related U.S. Application Data
(60) Provisional application No. 62/814,112, filed on Mar. 5, 2019.

(51) Int. Cl. A62B 17/00; A41B 1/08; A41D 1/06; A41D 27/28; A41D 31/102; A41D 31/24; A41D 31/30; A41D 13/01; A41D 13/015

(52) U.S. Cl. CPC A62B 17/003; A41B 1/08; A41D 1/06; A41D 27/285; A41D 31/102; A41D 31/24; A41D 2300/22; A41D 13/01; A41D 13/0156; A62B 17/005; A62B 17/006; A62B 17/001; A41D 31/30

(57) ABSTRACT

A multi-threat base ensemble is provided that can include a shirt and pants. The shirt and pants provide flame and chemical protection to a wearer such as a first responder. The base ensemble also includes a targeted hazard protection system providing protection to the wearer at predetermined areas and a cinching system for selectively adjusting a portion of the shirt or pants allowing the targeted hazard protection system to be selectively drawn into proximity with a body of the wearer. Areas of stretchable ventilation and selectively-actuated ventilation openings, and additional comfort and protection elements are also provided.

### CROSS-REFERENCE TO RELATED APPLICATIONS

This application claims the benefit of and priority to U.S. Provisional Application Ser. No. 62/814,112, having the title “Advanced Multi-Threat Base Ensemble for Emergency Responders”, filed on Mar. 5, 2020, the disclosure of which is incorporated herein by reference in its entirety.

### STATEMENT REGARDING FEDERALLY SPONSORED RESEARCH OR DEVELOPMENT

This invention was made with government support under grant number 2014-ST-108-FRG003 awarded by the U.S. Department of Homeland Security (DHS). The government has certain rights in the invention.

### FIELD OF THE INVENTION

The present disclosure relates generally to protective garments. More particularly, disclosed herein is a base ensemble operative to protect emergency responders from multiple threats of bodily harm while being sufficiently comfortable for daily wear and compatible with other Personal Protective Equipment.

### BACKGROUND

Firefighters, emergency medical responders, and members of law enforcement each have specialized equipment and wearable gear designed to protect them from particular hazards. Firefighters, for example, have heavy structural turnout gear, such as turnout jackets, pants, or overalls, that operates as personal protective equipment (PPE). Such specialized gear is normally worn as an outer layer of protective clothing. Similarly, law enforcement personnel have protective equipment, such as body armor, that is typically worn over or under the officer's standard-issue uniform. Still further, emergency medical services personnel have protective masks, gloves, and other equipment worn in supplementation of their standard uniforms.

While the foregoing and other primary protective gear is certainly useful and necessary for its intended purpose, each of these first responders normally wear a base uniform to be supplemented by the protective gear. That primary protective gear is normally donned only when the person is entering a known threat or hazard with adequate warning. Often, such base uniforms provide little by way of specialized function and protection. Accordingly, without specialized, dedicated gear in supplementation of the first responder's standard-issue uniform, the first responder is without particularized protection against threats of bodily harm, and the first responder has only whatever protection his or her standard-issue uniform might happen to provide.

However, first responders are exposed to multiple potentially unexpected threats and hazards, even at times when specialized protective gear might not be worn and the first responder is wearing only his or her base uniform, such as in the event of unforeseeable emergencies. Existing base uniforms typically provide little, if any, protection against unexpected threats. Moreover, first responders experience numerous threats and hazards that even their personal protective equipment is not designed to handle.

Many uniforms that are made available to first responders have significant shortcomings and limitations when worn on a daily basis by the emergency personnel. For example, many uniforms are restrictive and limit the mobility of the wearer. These uniforms often lack features that facilitate the mobility and comfort of the wearer. They promote discomfort and possible damage to the garment when personnel undertake the strenuous movements common in their respective professions. Furthermore, the uniforms commonly fail to provide specialized features that emergency personnel may seek or require.

Still further, most protective equipment is focused on protecting against just a single threat, such as flame resistance or resistance to bloodborne pathogens. Moreover, disclosed protective equipment normally has the same level of protection throughout the entire garment or other type of equipment. Rather than providing targeted protection to areas of elevated vulnerability, homogenous characteristics exist throughout so that the equipment is further rendered uncomfortable and effectively incapable of being worn except when the first responder is confronting a known, expected hazard.

Meanwhile, the Standard on Emergency Services Work Clothing Elements set forth by the National Fire Protection Association as NFPA 1975 specifies the standard that safeguards emergency services personnel on the job. This standard specifies requirements for the design, performance, testing, and certification of non-primary station and work apparel uniforms and the individual garments comprising station and work apparel uniforms. Among the specifications is that requiring flame-resistant station uniform clothing that won't cause or exacerbate burn injury. The standard also specifies requirements for the thermal stability of textiles used in the construction of such uniforms and optional requirements for flame resistance, moisture management, odor resistance, water resistance, and visibility markings.

It is thus apparent to the present inventors that it would be highly advantageous to provide a protective ensemble for emergency responders that can be worn comfortably on a daily basis while providing enhanced functionality and providing protection to the wearer from multiple hazards and threat sources.

### SUMMARY

The present disclosure provides examples of multi-threat base ensembles for the protection of a wearer and the like.

An embodiment of the present disclosure includes a multi-threat base ensemble including a base ensemble shirt and base ensemble pants. The base ensemble shirt and the base ensemble pants can include materials that provide flame and/or chemical protection to a wearer. The multi-threat base ensemble can also include a targeted hazard protection system providing functional protection to the wearer at predetermined areas of the shirt and/or the pants. The targeted hazard protection system can be multi-layered, having upper and lower pads between a knit layer and a woven layer, where the upper and lower pads can include a liquid impervious membrane and protuberances disposed on the liquid impervious membrane. The multi-threat base ensemble can also include a cinching system that can selectively adjust a portion of the shirt or the pants between a cinched condition and a non-cinched condition, which can allow the targeted hazard protection system to be selectively drawn into proximity with a body of the wearer. The multi-threat base ensemble can also include areas of stretchable ventilation incorporated within the shirt and the pants to provide air ventilation to the wearer, along with additional selectively-actuated ventilation openings.

Other compositions, apparatus, methods, features, and advantages will be or become apparent to one with skill in the art upon examination of the following drawings and detailed description. It is intended that all such additional compositions, apparatus, methods, features and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 is an anterior perspective view of an advanced multi-threat base ensemble in accordance with various embodiments of the present disclosure;

FIG. 2 is a posterior perspective view of a multi-threat base ensemble in accordance with various embodiments of the present disclosure;

FIG. 3 is a view in front elevation of a multi-threat base ensemble shirt in accordance with various embodiments of the present disclosure;

FIG. 4 is a view in rear elevation of a multi-threat base ensemble shirt in accordance with various embodiments of the present disclosure;

FIG. 5 is a view in front elevation of multi-threat base ensemble pants in accordance with various embodiments of the present disclosure;

FIG. 6 is a view in rear elevation of the multi-threat base ensemble pants in accordance with various embodiments of the present disclosure;

FIG. 7 is an amplified posterior view of a knee portion of the multi-threat base ensemble pants depicting the adjustable knee pad system in a pulled configuration in accordance with various embodiments of the present disclosure;

FIG. 8 is an amplified posterior view of an example of the knee portion of multi-threat base ensemble pants in a flat configuration in accordance with various embodiments of the present disclosure;

FIG. 9 is an amplified side elevation view of a knee portion of multi-threat base ensemble pants in accordance with various embodiments of the present disclosure;

FIG. 10 is a view in front elevation of an example of multi-threat base ensemble pants with the front closure in an open configuration in accordance with various embodiments of the present disclosure;

FIG. 11 is an amplified view of a cargo pocket portion of a multi-threat base ensemble pants in accordance with various embodiments of the present disclosure;

FIG. 12 is an amplified rear elevation view of a rear pocket portion of the multi-threat base ensemble pants in accordance with various embodiments of the present disclosure;

FIG. 13 is an amplified front elevation view of a knee portion of the multi-threat base ensemble pants in accordance with various embodiments of the present disclosure;

FIG. 14 is an amplified view in front elevation of a collar portion of multi-threat base ensemble shirt in a closed configuration and with a deployable reflective tab in a deployed position in accordance with various embodiments of the present disclosure;

FIG. 15 is an amplified view in front elevation of the collar portion of the multi-threat base ensemble shirt in an open configuration and with the deployable reflective tab in a non-deployed position in accordance with various embodiments of the present disclosure;

FIG. 16 is an amplified view in rear elevation of a venting structure for the multi-threat base ensemble shirt in accordance with various embodiments of the present disclosure;

FIG. 17 is a side elevation view of a side panel structure of the multi-threat base ensemble shirt in accordance with various embodiments of the present disclosure;

FIG. 18 is a view in rear elevation of side panel and rear shoulder structures of a multi-threat base ensemble shirt in accordance with various embodiments of the present disclosure;

FIG. 19A is a view in front elevation of an example pocket structure of a multi-threat base ensemble shirt in accordance with various embodiments of the present disclosure;

FIG. 19B is a view in rear elevation of a pocket structure of a multi-threat base ensemble shirt in accordance with various embodiments of the present disclosure;

FIG. 20 is a view in front elevation of a multi-threat base ensemble shirt in a partially opened configuration in accordance with various embodiments of the present disclosure;

FIG. 21A is a view in front elevation of an example of membranes of a knee pad system during a stage in the formation thereof, in accordance with various embodiments of the present disclosure;

FIG. 21B is a view in rear elevation of an example of membranes of a knee pad system during a stage in the formation thereof, in accordance with various embodiments of the present disclosure;

FIG. 22A is an amplified view in front elevation of a portion of a membrane of the knee pad system in accordance with various embodiments of the present disclosure;

FIG. 22B is an amplified view in rear elevation of a portion of a membrane of the knee pad system in accordance with various embodiments of the present disclosure.

FIG. 23 is a cross-section view of an example of the multi-layer anterior knee panel in accordance with various embodiments of the present disclosure.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure can employ, unless otherwise indicated, techniques of chemistry, material science, and the like, which are within the skill of the art.

The following examples are put forth so as to provide those of ordinary skill in the art with a complete disclosure and description of how to perform the methods and use the materials and garments disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It is noted that, as used in the specification and the appended claims, the singular forms “a,” “an,” and “the” include plural referents unless the context clearly dictates otherwise.

As used herein, the following terms have the meanings ascribed to them unless specified otherwise. In this disclosure, “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

### General Discussion

Provided herein is an advanced base ensemble that provides protection against multiple threat sources for the wearer, where the wearer can be personnel such as first responders.

Embodiments of the disclosure can provide an advanced base ensemble for first responders that is compatible with other primary Personal Protective Equipment.

Embodiments of the disclosure can provide an advanced multi-threat base ensemble for the wearer (e.g. a first responder) that provides functional protection from daily hazards while permitting comfortable wear as a daily base uniform.

Embodiments of the present disclosure can provide an advanced multi-threat base ensemble for first responders that exhibits enhanced durability.

Embodiments of the present disclosure can provide an advanced multi-threat base ensemble for first responders that is capable of being manufactured in compliance with the Standard on Emergency Services Work Clothing Elements of the National Fire Protection Association's NFPA 1975, including potentially with respect to flame resistance, water resistance, and odor resistance.

In certain practices of the present disclosure, other objects include providing an advanced multi-threat base ensemble that demonstrates flame resistance, water resistance, and, additionally or alternatively, odor-resistance.

Embodiments of the present disclosure can provide the wearer with a base ensemble that demonstrates added flame resistance, liquid repelling, and protection against, for instance, sharp objects at an emergency scene while remaining sufficiently comfortable and appealing for such as an emergency responder to wear while working a lengthy shift.

Embodiments or portions of embodiments of the present disclosure can provide an advanced multi-threat base ensemble that can be quickly and conveniently donned and doffed, including to permit rapid removal of the base ensemble in the event of contamination.

Particular manifestations of the present disclosure can provide an advanced multi-threat base ensemble with impact, flame, chemical and, additionally or alternatively, cut protection incorporated substantially throughout the base ensemble or within particular protective areas of the base ensemble.

Embodiments of the present disclosure can provide an advanced multi-threat base ensemble with incorporated ventilation, potentially selectively actuated ventilation, to minimize the thermal burden to the wearer.

Embodiments of the present disclosure can provide an advanced multi-threat base ensemble with incorporated moisture wicking materials, particularly in areas of expected high levels of perspiration, to aid in cooling, reduce thermal burden, and increase comfort to the wearer.

Embodiments of the present disclosure can provide an advanced multi-threat base ensemble that provides targeted protection, which may be characterized as functional protection, to contribute to enhanced comfort and wearability while providing enhanced threat resistance in hazardous areas.

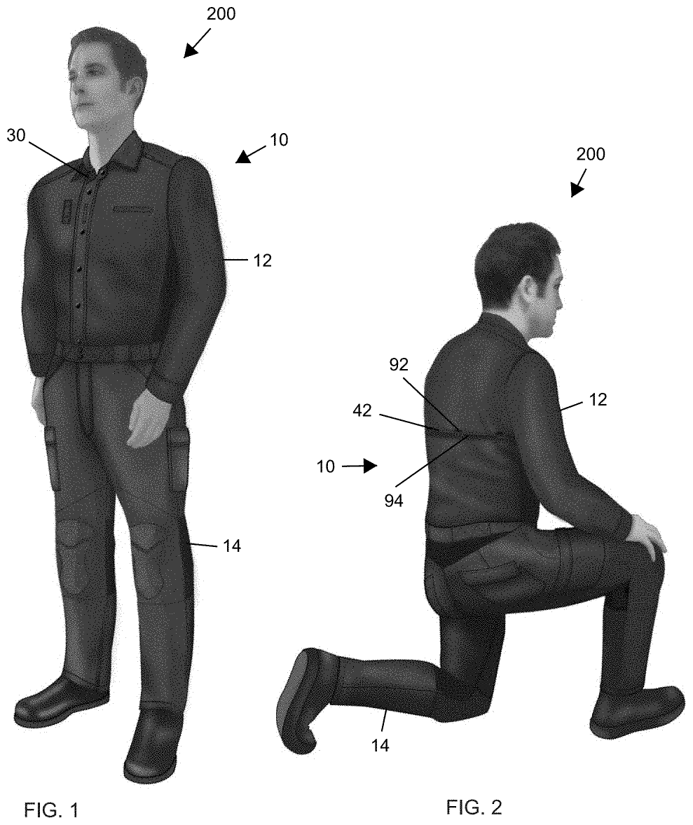

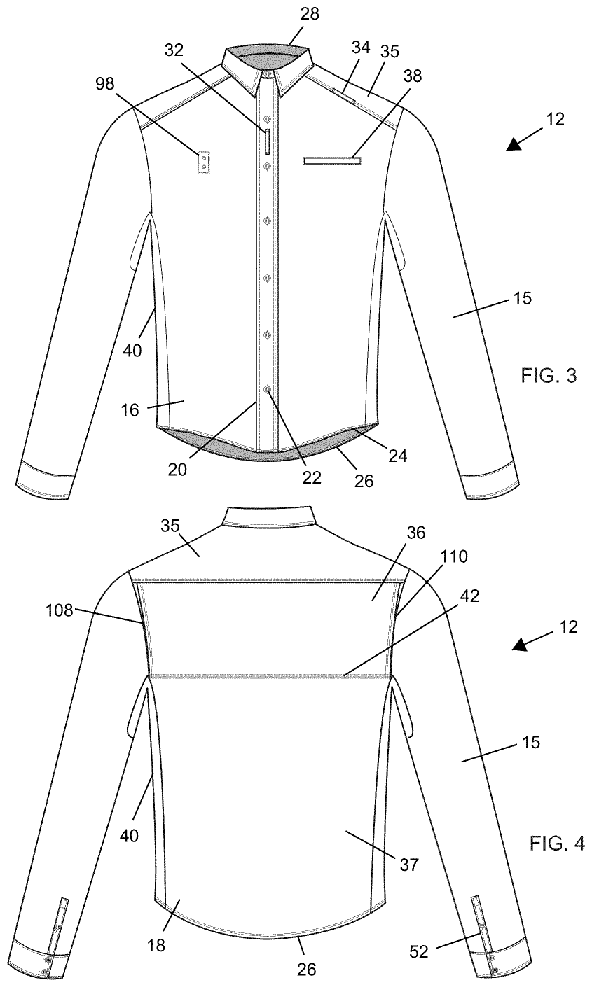

One potential embodiment of the present disclosure for an advanced multi-threat base ensemble is indicated generally at 10 in FIGS. 1 and 2. There, the base ensemble 10 is formed by a multi-threat base ensemble shirt 12 in combination with multi-threat base ensemble pants 14. The base ensemble 10 is crafted for daily wear by a wearer 200, where the wearer 200 may be a first responders, such as firefighters, law enforcement officers, or emergency medical service providers. The base ensemble 10 is operative to provide such first responder 200 with protection against multiple threat sources while remaining compatible with other primary Personal Protective Equipment. Emergency personnel can thus selectively supplement the threat protection provided by the base ensemble 10 with specialized protective equipment, such as firefighting turnout gear, hazardous material suiting, body armor, or other protective gear.

As discussed further below and as can be understood with additional reference to the drawings, the multi-threat base ensemble 10 for wearer 200 provides what may be referred to as functional protection from daily hazards while permitting comfortable wear as a daily base uniform. The multi-threat base ensemble 10 is designed and crafted to be capable of being manufactured to comply with the Standard on Emergency Services Work Clothing Elements of the National Fire Protection Association's NFPA 1975. By virtue of its construction characteristics, which can be understood with additional reference to the drawings and to the description below, the multi-threat base ensemble 10, particularly the shirt 12 of the base ensemble 10, can be quickly and conveniently donned and doffed, including to permit rapid removal of the base ensemble in the event of contamination, while providing effective protection against multiple threats. The multi-threat base ensemble 10 thus provides a more protective alternative to the standard duty or daily wear uniform. Particularly when employed in combination, the base ensemble 10 provides enhanced protection to the wearer 200 while permitting regular wear with improved thermal comfort, sensorial comfort, comfort in activity and fit, flexibility, and durability. By virtue of the enhanced comfort and increased mobility, fatigue during action is reduced.

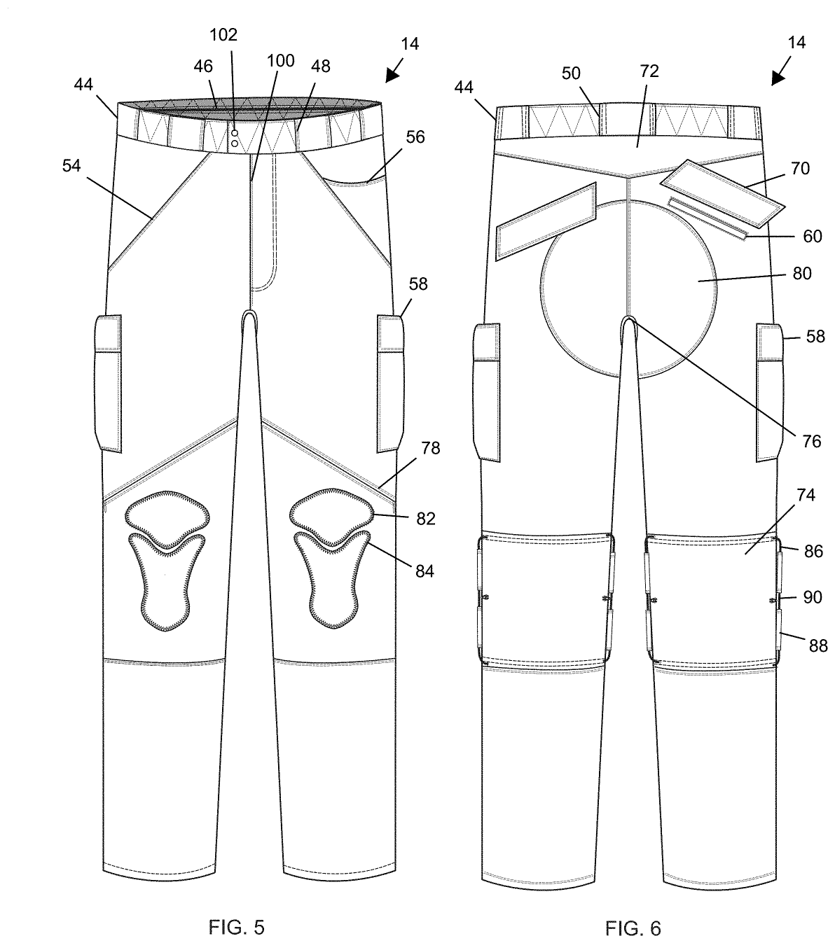

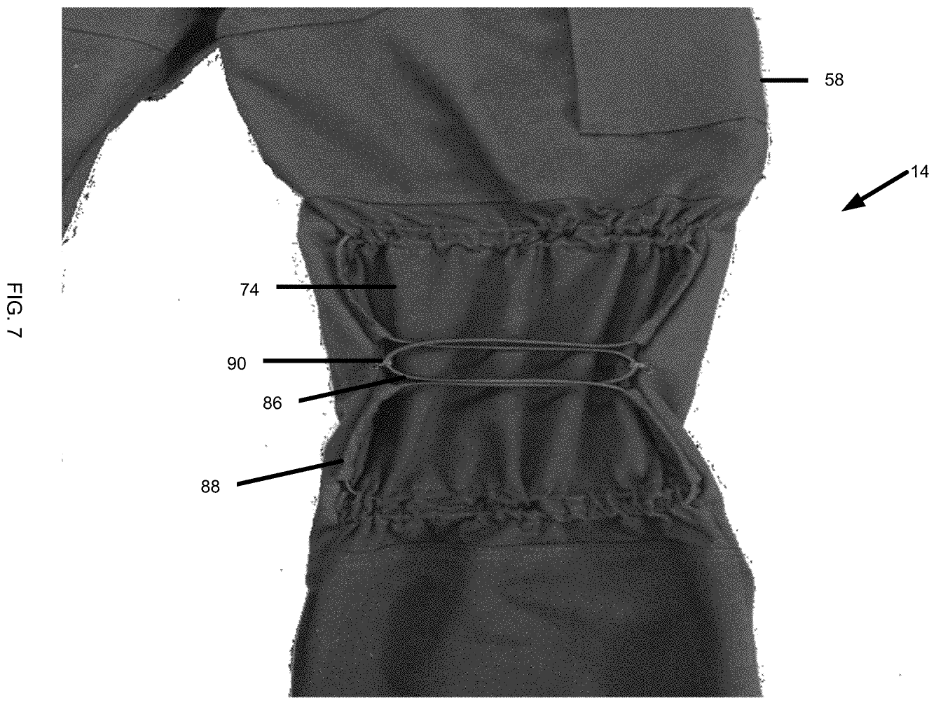

With further reference to FIGS. 3 and 4, an embodiment of the multi-threat base ensemble shirt 12 can be seen to have a front portion 16, a rear portion 18, and left and right arms 15. The shirt 12 in this manifestation is crafted to have the appearance of a button-down shirt so that it has a collar 28, a front placket 20 centrally disposed in the front portion 16 to communicate vertically from the collar 28 to the front hem 24 of the shirt 12, and arm plackets 52 disposed in the arms 15 to communicate a given distance proximally from the distal ends of the arms 15.

The front placket 20 of the shirt 12 in this embodiment, though, is a faux button placket 20. While the placket 20 is adorned with buttons 22 thereby giving a traditional and formalized look, the buttons 22 are non-functional and do not operate to close the front 16 of the shirt 12 as with traditional buttons and button-holes. Instead, a zipper 30 traverses under the front placket 20 from an upper end contiguous with the collar 28 to a lower end contiguous with the front bottom hem 24 of the shirt 12 to divide the front portion 16 of the shirt 12 into selectively engagable and separable left and right halves. One or more closures, such as a plurality of hook and loop combinations 31 can cooperate to retain the front placket 20 in a substantially flat configuration. With the adjustability of the zipper 30, the wearer can selectively close the entire front portion 16 of the shirt 12, and the wearer can selectively unzip the zipper 30 to the extent desired for venting, such as during periods of non-emergency activity, thereby providing added thermal comfort through, for instance, increased evaporative potential. Further, the zipper 30 can be rapidly closed to join the left and right halves of the front portion 16 of the shirt 12 in the event of an emergency or other need.

The zipper 30 also permits the shirt 12 to be quickly donned and doffed significantly faster than unbuttoning. The ability to apply the shirt 12 rapidly can be very beneficial to the first responder where the ability to respond quickly is important. Furthermore, rapidly removing the shirt 12 can be important where the shirt 12 becomes contaminated, such as with bodily fluids, chemicals, or other contaminants.

Even further, a zipper 30 is advantageous in providing continuous sealing along its length while actual buttons inevitably leave gaps between the connections of the left and right portions of the shirt 12. With an existing buttoned shirt, a first responder either accepts the existence of such open gaps or wears an undershirt that may contribute to uncomfortable heating or a loss in flexibility or mobility. Still further, where a button is lost, further gapping can be created as is a loss in functionality and appearance. A zipper 30 as provided hereunder presents a continuous barrier with improved liquid resistance as compared to a buttoned garment.

As shown in FIGS. 2 and 3, for example, the shirt 12 can have a front bottom hem 24 and a rear bottom hem 26. The front and rear bottom hems 24 and 26 in this example can be arcuate and are designed to provide a presentable appearance whether tucked or untucked.

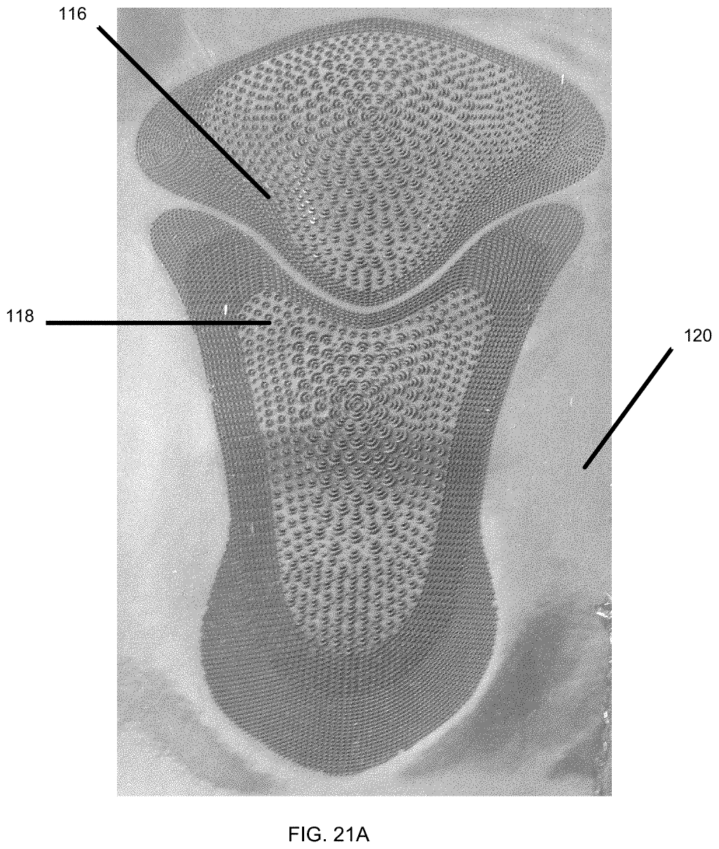

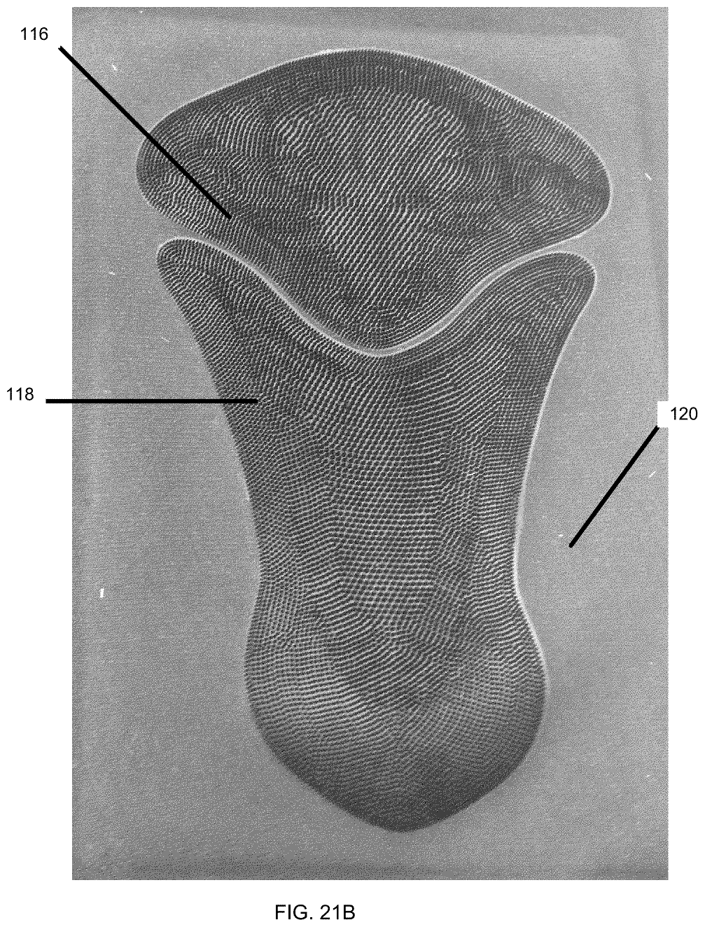

The multi-threat base ensemble shirt 12 can further include a chest pocket 38, such as in a left chest portion thereof, and a badge holder 98, such as in a right chest portion thereof. The chest pocket 38 can be a welt pocket that does not include a traditional flap. The welt chest pocket 38 gives a straight, streamlined appearance and function and eliminates the potentially disheveled appearance of an overturned flap, which might require pressing or other action to compel to a flat, neat condition. The chest pocket 38 can have a pocket bag that is large enough to keep writing materials and to retain and store other items that may be needed by a first responder. As shown in FIGS. 19A and 19B, for example, the chest pocket 38 can have a separate sub-channel 114 therewithin that is adapted for retaining a writing implement. There is stitching across the bottom of the sub-channel 114 to prevent the writing implement from being inserted so far that it would become stuck. The sub-channel 114 can be wide enough to receive a writing implement but is sufficiently narrow to prevent the writing implement from becoming trapped in a sideways or lateral position.

The multi-threat base ensemble shirt 12 can incorporate further features that facilitate comfortable, daily wear of the shirt 12 while providing threat protection. For example, in some embodiments a shoulder yoke 35 spans from an anterior portion connected to the front portion 16 of the shirt 12 to a posterior portion connected to the rear portion 18 of the shirt 12. Thus, a continuous panel of fabric is presented at the tips of the shoulders of the shirt 12 by the shoulder yoke 35. With that, added comfort is provided by the elimination of a seam atop the shoulders. Such seams can be problematic and can uncomfortably pressed down into the wearer's shoulder, such as in instances where body armor or other gear is worn over the multi-threat base ensemble shirt 12.

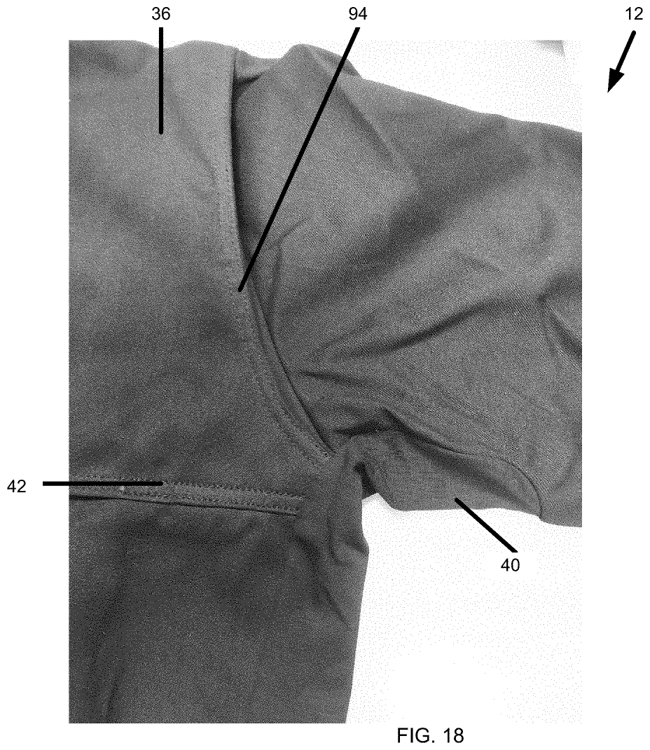

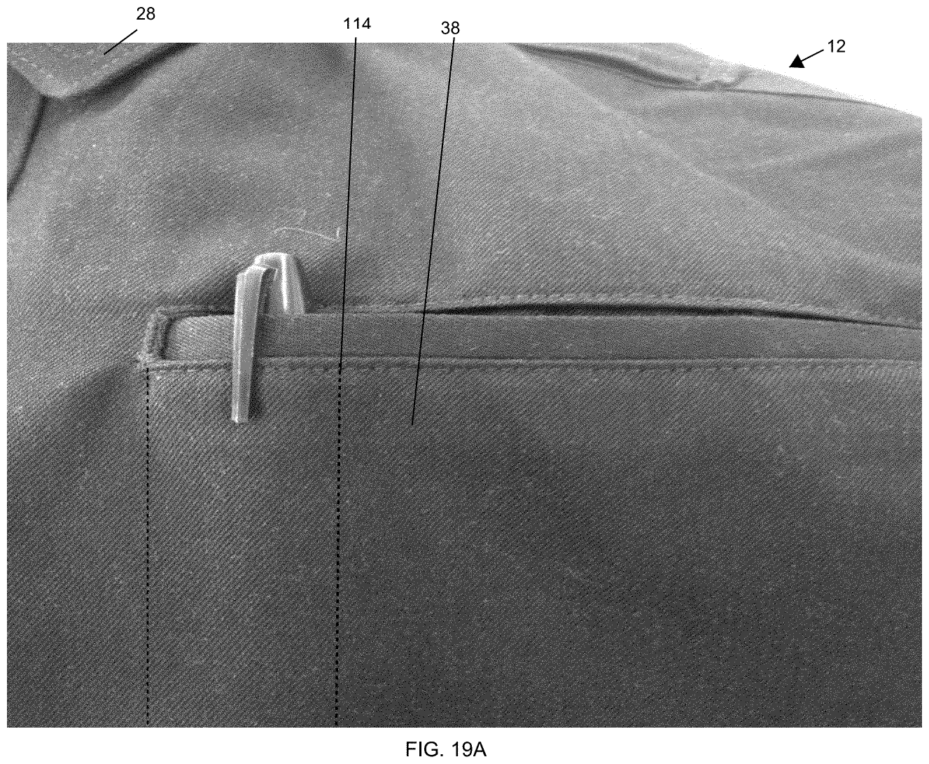

The shoulder yoke 35 has a lower posterior edge that spans across the rear portion 18 of the shirt 12 from the left shoulder seam 108 to the right shoulder seam 110. A shoulder panel 36 spans from the left shoulder seam 108 to the right shoulder seam 110. An upper edge of the shoulder panel 36 is stitched or otherwise connected to the lower edge of the shoulder yoke 35. A lower edge of the shoulder panel 36 can be intermittently connected to a lower panel 37 of the rear portion 18, such as by tacking stitching 92 as can be best seen in FIGS. 15 and 16, for example. The tacking stitching 92 presents spaced connections between the shoulder panel 36 and the lower panel 37 with substantial gaps therebetween to permit air flow and venting between the shoulder panel 36 and the lower panel 37. A sub-layer 94, such as a knit sub-layer 94, underlies the shoulder panel 36 and presents a continuous surface below the shoulder panel 36, such as by being continuously fastened to the lower panel 37. With this, the rear portion 18 of the shirt 12 is comfortably vented while a continuous protective layer is provided to the wearer. The knit sub-layer 94 is, in certain embodiments, crafted from moisture wicking, fire resistant, antimicrobial knit fabric.

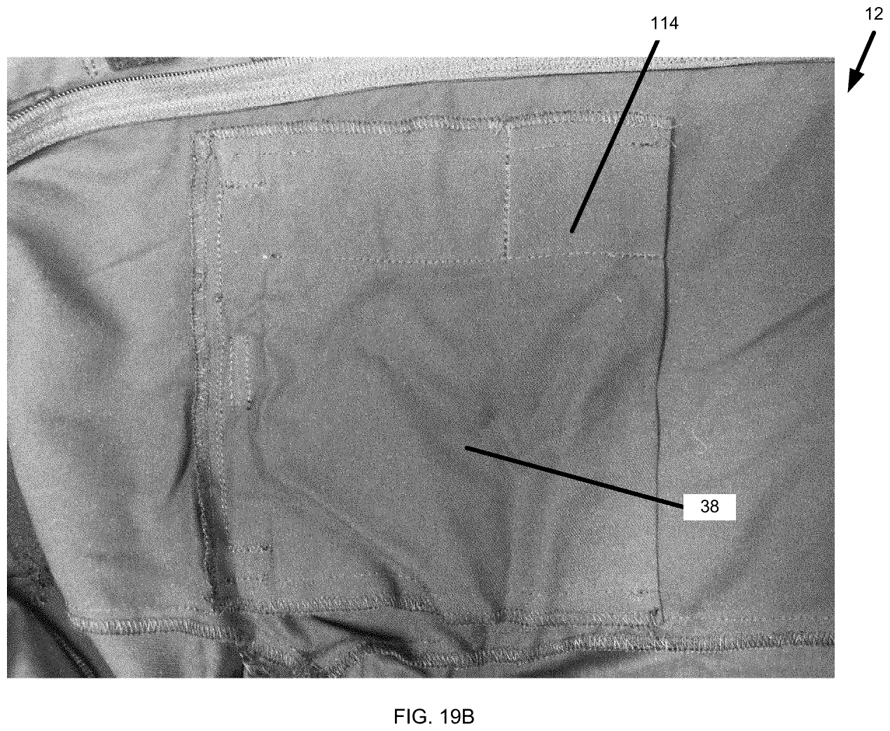

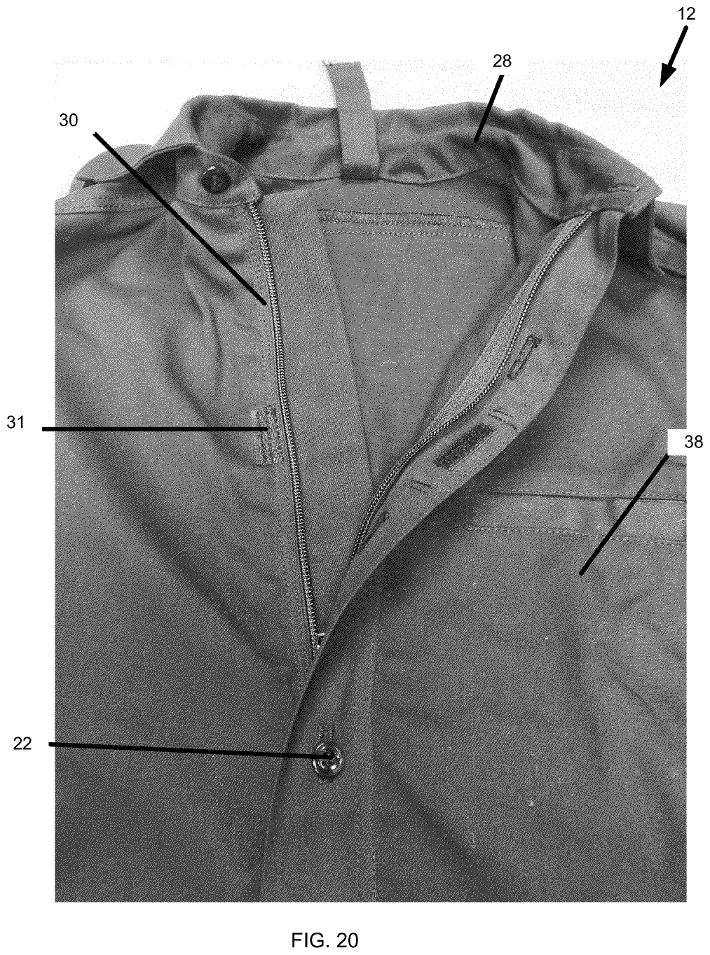

As can be perceived by reference, for example, to FIGS. 3 and 4 and as can be further understood with added reference to FIG. 17, a side panel 40 can be disposed on each side of the multi-threat base ensemble shirt 12. The side panel 40 is bounded along an anterior edge by the front portion 16 of the shirt 12 and a portion of the arm 15 and on a posterior edge by the lower panel 37, the shoulder panel 36 of the rear portion 18, and the yoke 35. The side panels 40 terminate at the hems 24 and 26 at a first end thereof, span the underarms, and terminate at a second end spaced along the length of the arm 15. The side panel 40 is crafted from a breathable, stretchable knit fabric thereby not only eliminating some or all of an underarm seam but also providing ventilation, moisture management, and antimicrobial characteristics to the underarms where such properties may be particularly valuable. Furthermore, the side panel 40 provides stretch that allows the shirt 12 to give when a wearer stretches or turns and permits the shirt 12 to fit a wider range of body types more comfortably. For example, a wearer with a larger or protruding abdomen may still attain a comfortable fit from a given size shirt 12 without having to choose larger size just to accommodate the abdomen while sacrificing fit elsewhere. Furthermore, the side panels 40 provide venting to each side of the shirt 12 thereby facilitating cross ventilation.

By way of example and not limitation, the side panels 40 can be crafted from a mesh material to facilitate air flow. Alternatively, the side panels 40 can be formed from a moisture wicking knit for added moisture wicking. Still further, an individual material or layers of material can be employed to provide both functions.

The rear portion 18 of the multi-threat ensemble shirt 12 has articulated shoulder portions 108 and 110. On each side, a knit panel 112 is attached as a pleat that is secured to the shirt shoulder panel 36 and to the rear of the sleeve of the arm 15. This inset knit panel 112 allows flexibility and stretching across the back portion 18, such as when reaching. The flexibility contributes to added comfort in the shirt 12 and adds to the life and durability of the garment since tears from overextending will be minimized. Furthermore, the extra flexibility and stretch in this area allows the first responder to be more hands-on and to have more mobility not only in emergency situations but also in everyday wear. Such improved fit, added comfort, and increased mobility contribute to reduced fatigue even during strenuous activity.

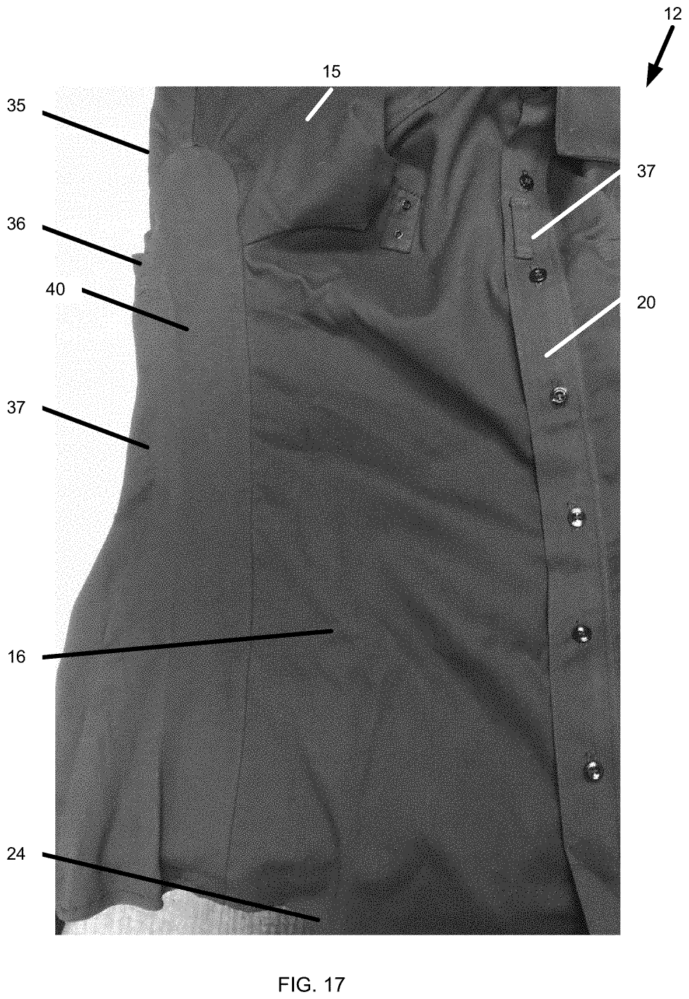

With particular reference to FIGS. 14 and 15, embodiments of the multi-threat ensemble shirt 12 incorporate a selectively-deployed reflective material. It will be understood that the selectively-deployed reflective material could be retained and selectively deployed in a plurality of different ways within the scope of the present disclosure except as the claims might be expressly limited. For example, in a tactical situation in which it would be beneficial for the wearer to remain unseen, the reflective material can be hidden (e.g. tucked away). In other situations, when directing traffic for example, the wearer can selectively deploy (e.g. display) the reflective material. In the particular embodiment shown in FIGS. 14 and 15, the selectively-deployed reflective material is embodied as a tab or strap 104 with reflective material retained thereby. The selectively-deployed strap 104 has a first end fastened to the base of the collar 28 and a free, elongate body portion with a first surface and a second surface. Reflective material is retained by the selectively-deployed strap 104, such as by having a panel of reflective material affixed to the first surface of the elongate body portion. In various embodiments, the selectively-deployed reflective material can be included in other areas, such as but not limited to under the cargo pocket flaps, the collar, inside the knee vent zipper, under the back pocket flaps, inside front chest pocket, or in sleeve cuffs that can be rolled up to expose the reflective material).

When the selectively-deployed strap 104 is disposed in a non-deployed position as in FIG. 15, the strap 104 lies flat against the sub-layer 94 that underlies the shoulder panel 36 with the first surface, which includes the reflective material, against the sublayer 49 and thus facing away from the wearer and the interior of the shirt 12. When desired, such as in an emergency situation at night, the selectively-deployed strap 104 can be flipped outwardly thereby to cause the body portion of the strap 104 to be exterior to the interior of the shirt and to overlie the collar 28 and potentially a portion of the yoke 35 with the reflective material facing outwardly. Under this construction, reflective visibility can be minimized when desired by maintaining the strap 104 within the shirt 12, and reflective visibility can be maximized when desired by flipping the strap 104 to be deployed outside of the interior of the shirt 12.

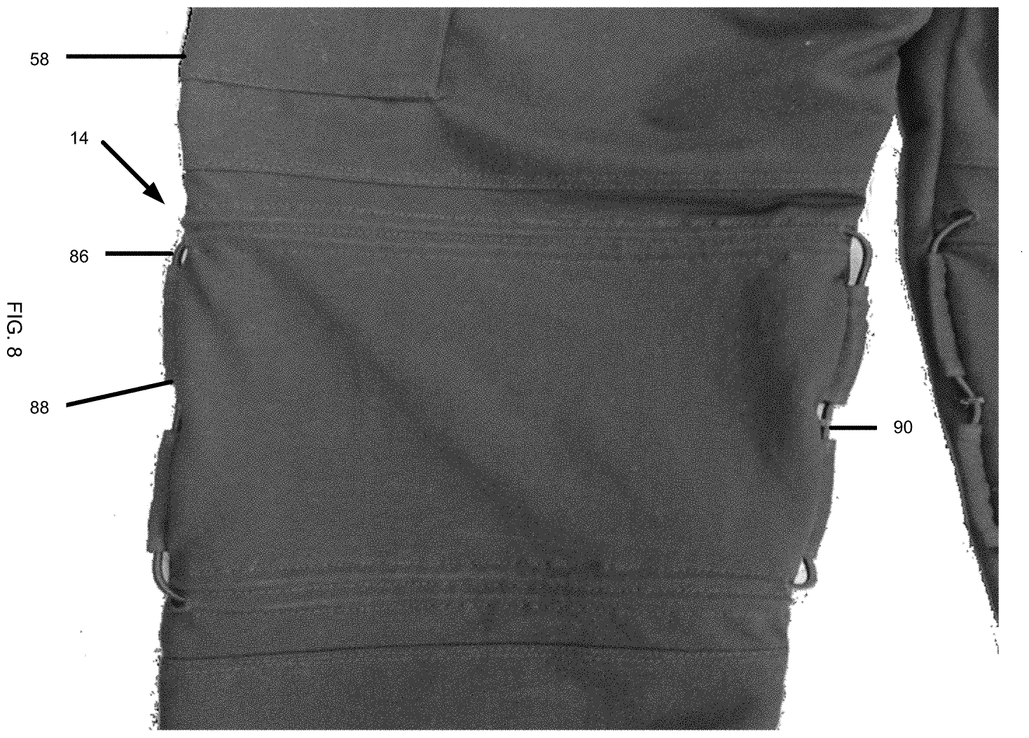

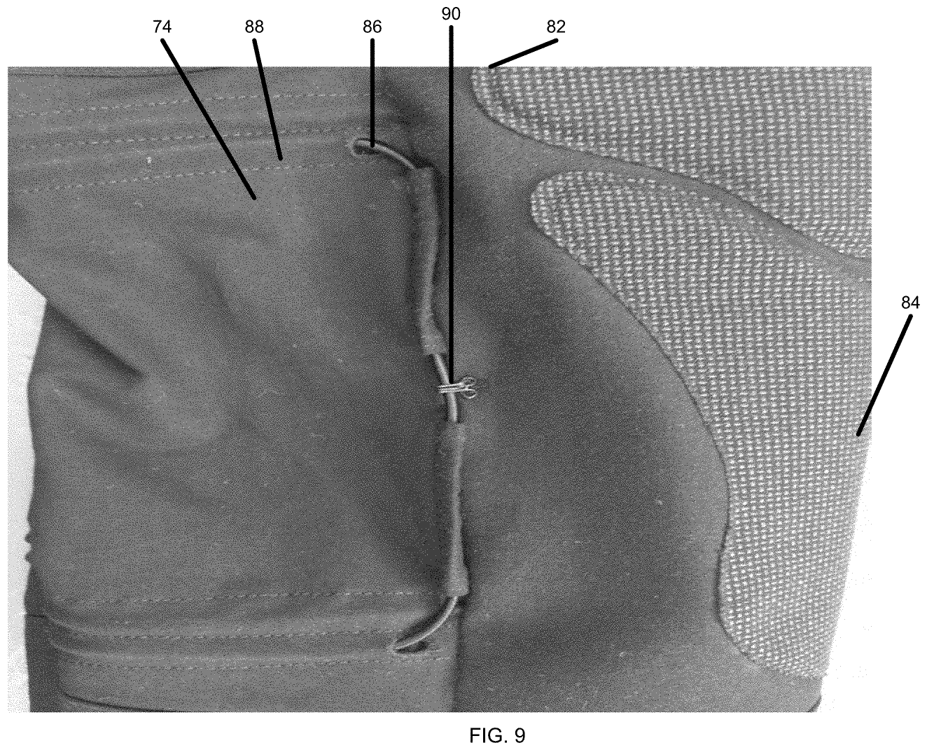

Turning to FIGS. 5 and 6 and further drawings as referenced herein, the multi-threat base ensemble pants 14 incorporate further features and protections particularly designed for first responders. Considering first the waistband 44 of the pants 14, a fire-resistant padded batting can fill the waistband 44. The waistband 44 can be quilted. Bearing in mind the stresses applied to first responder's bodies and garments, such as the common need to carry weighty utility belts, this padded batting can promote comfort, such as on the waist and hips, while improving the durability of the base ensemble pants 14 and, as a result, potentially improving the endurance and performance of the first responder.

The multi-threat base ensemble pants 14 have a material with a high coefficient of friction, alternatively referred to as a highly tacky material, along some or substantially the entirety of the inner surface of the waistband 44. In a particular embodiment, the high coefficient-of-friction material comprises a band 46 of silicone twill tape stitched along the inner surface of the waistband 44. The high coefficient-of-friction material aids in keeping the pants 14 in position on the wearer's hips and in keeping the multi-threat ensemble base shirt 12 tucked in where desired. The high coefficient-of-friction material tends to assist in keeping the pants 14 and the shirt 12 or other garment in position and laying in the intended disposition. In this regard, it is recognized that keeping the shirt 12 tucked in not only adds to the appearance of the wearer but it also can provide vital protective capability by keeping skin from being exposed during action. In other embodiments, the high coefficient-of-friction material could be applied to the shirt 12 or both the shirt 12 and pants 14. Other materials having a high coefficient of friction could also be envisioned by one of ordinary skill in the art, such as those generally referred to as non-slip fabrics or grip fabrics. Examples can include such as base textile materials with coatings, beads or yarns integrated to the fabric. The beads or yarns can include e.g. PVC, thermoplastic rubber or other rubbers such as natural, butyl, Nitrile, neoprene, latex, and the like. The waistband 44 and the front of the waist portion of the pants 14 in general can be selectively closed by a zipper 100 in combination with snap buttons 102 or another closure mechanism. In other embodiments, as can be envisioned by one of ordinary skill in the art, other fastening means can be used to attach the shirt 12 and pants 14 (e.g. snaps, elastic, zippers, and/or velcro). Alternatively, the base ensemble could be a one piece such as a jumpsuit. In other embodiments, the base ensemble can comprise a separate shirt 12 that is long enough to remain tucked into pants 14 while the wearer performs bending activities.

The multi-threat base ensemble pants 14 can have a plurality of peripheral belt loops 48 spaced around the exterior of the waistband 44 and a rear belt loop 50 generally centered relative to the posterior of the waistband 44. The waistband 44 and the belt loops 48 and 50 are designed to be taller than those traditionally found on first responder uniforms. The added height of the loops 48 and 50 permit wider utility belts to be received. Furthermore, rather than being stitched externally to the top of the waistband 44, the belt loops 48 and 50 have end portions sewn into the seam allowance of the waistband 44, which allows extra space for topstitching that would otherwise limit the width that can clear this area. The rear belt loop 50 is of an extended length, effectively spanning approximately the distance over which two posterior belt loops are normally spaced. The longer rear belt loop 50 prevents excess pulling and deformation in the posterior waistband 44 that often deforms belts using belt loops and waistbands into a V-shape over time. With the extended length belt loop as disclosed herein, the belt can move and react with the pant in a more unitary fashion to prevent deformation and discomfort.

The multi-threat base ensemble pants 14 of the depicted embodiment have at least seven pockets. On the anterior portion of the pant, two front waist pockets 54 are disposed beginning at or adjacent to the waistband 44 evenly spaced on the anterior portion of the pants 14, and a coin pocket 56 is disposed to underlie one of the front waist pockets 54. A cargo pocket 58 is disposed on each thigh of the pants 14, and two rear pockets 60 are disposed adjacent to the waistband 44 evenly spaced on the posterior portion of the pants 14. The openings of the rear pockets 60 are disposed generally along a diagonal, which corresponds to the typical angle of insertion of a wearer's hand when reaching into a back pocket. This is intended to overcome the difficulties and limitations exhibited by horizontally straight pocket openings where the natural maneuverability of the body is not given proper account. The diagonal configuration of the pocket openings is more conducive to ease of use. In other embodiments, as can be envisioned by one of ordinary skill in the art, other appropriate numbers of pockets can be included, such as 4 or more, 5 or more, 6 or more, 7 or more, 8 or more, etc.

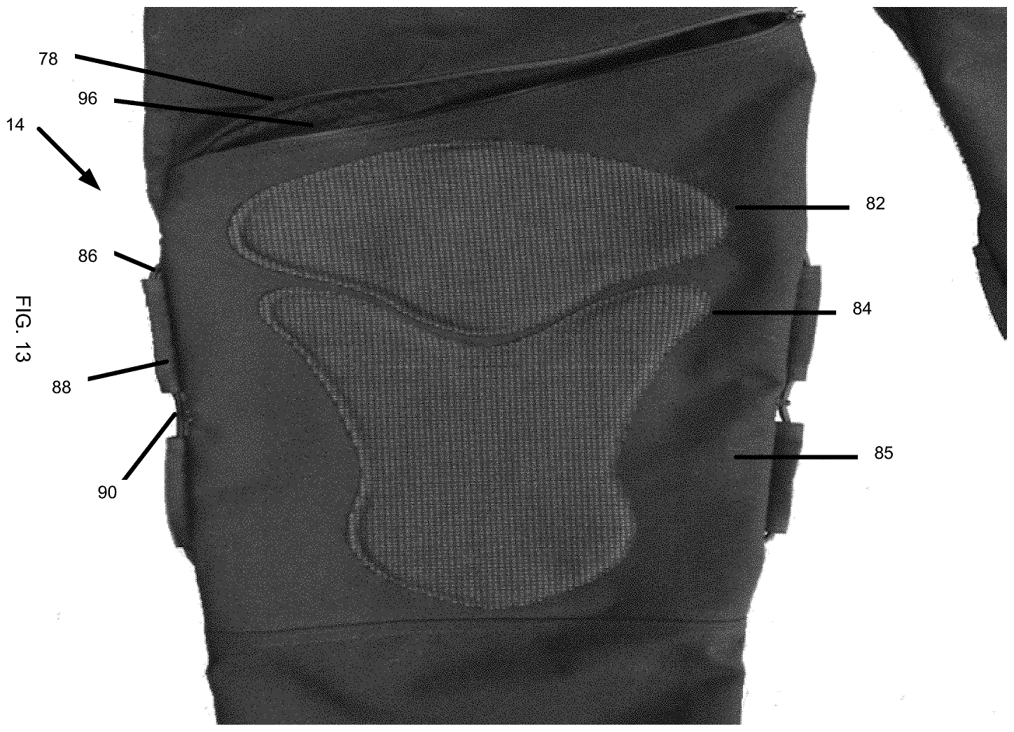

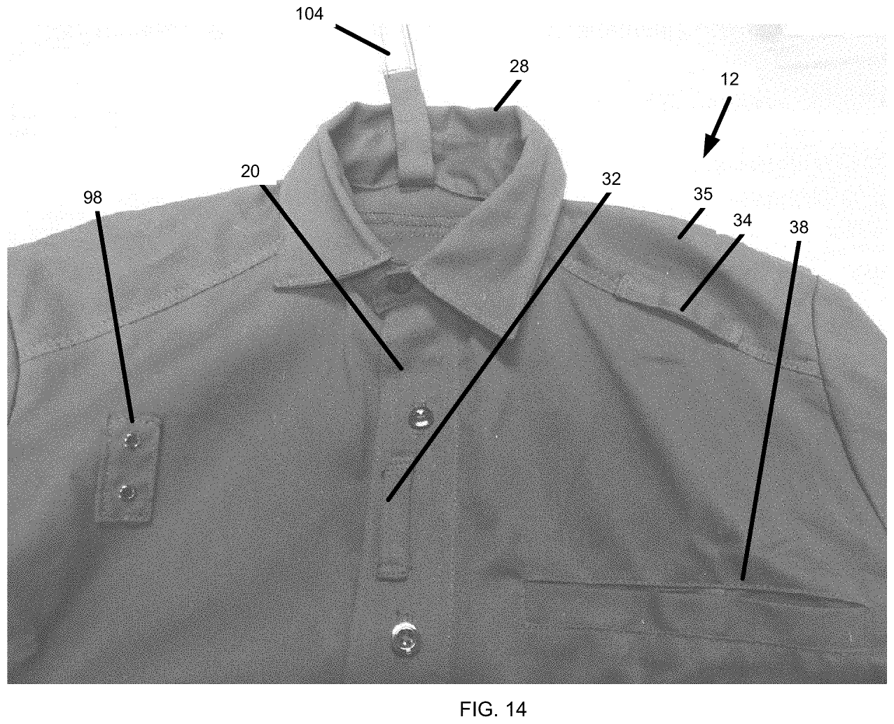

Looking to FIGS. 10 and 11, for example, the cargo pockets 58 each have a selectively-deployed flap 62 that can be disposed in a first, non-deployed configuration tucked into the cargo pocket 58 and in a second, deployed configuration overlying the open entrance to the cargo pocket 58. When in the deployed configuration, the flaps 62 can be selectively attached to the exterior surface of the cargo pocket 58 thereby to effectively seal the cargo pocket 58 by pressure buttons 64, which may alternatively be referred to as snap fasteners 64. Each pressure button 64 has a male stud couple retained relative to a first surface, such as the exterior of the cargo pocket 58, and a female stud couple retained relative to a second surface, such as the underside of the flap 62. The male and female stud couples can be selectively, matingly engaged. In other embodiments, as can be envisioned by one of ordinary skill in the art, other fastening means can be used to seal the cargo pocket 58 (e.g. snaps, magnets, toggles, elastic, hook and eyes, snap-fit buckle, zippers, and/or velcro).

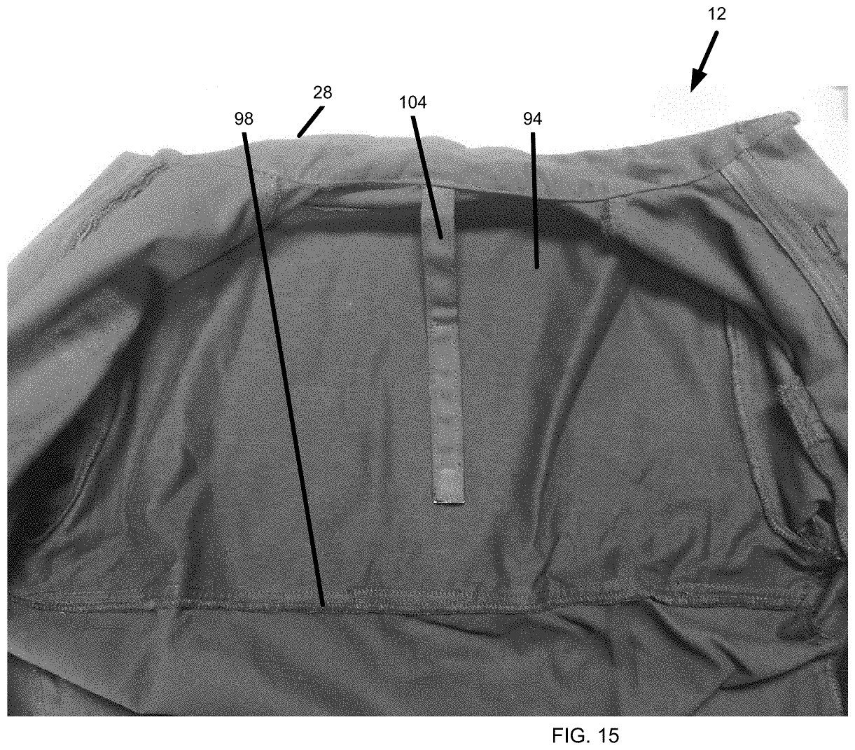

In a similar manner, as in FIG. 12, the rear pockets 60, which can comprise welt pockets 60, can have selectively-deployed flaps 70 that are, like the rear pockets 60 themselves, disposed along a diagonal. Pressure buttons 68 are retained to selectively close the flaps 70 of the rear pockets 60. With that, the flaps 62 and 70 and the pockets 58 and 60 can be readily accessed, opened, closed, and adjusted between deployed and non-deployed configurations depending on the needs of the first responder with less required effort and focus as compared to traditional button and button-hole combinations, particularly behind the wearer's back. Further, the pressure buttons 64 and 68 have the male and female stud couples disposed on the facing surfaces of the flaps 62 and 70 and the pockets 58 and 60 to eliminate the glint of the pressure buttons 64 and 68 and to reduce the potential marring thereof when the flaps are deployed.

The pants 14 retain a selectively-deployed reflective material. Again, it will be understood that the selectively-deployed reflective material could be retained and deployed under different constructions within the scope of the present disclosure. In this exemplary embodiment, the bags of the cargo pockets 58 have a reflective material 66, such as a strip of reflective material, affixed thereto. More particularly, reflective material 66 is disposed to span the upper edge of the cargo pocket 58. The flaps 62 and the reflective material 66 are sized so that the flaps 62 cover the reflective material when deployed and so that the reflective material 66 is exposed when the flaps are not deployed. Under this construction, the wearer can have minimized reflectivity when desired and can have enhanced reflectivity provided by the reflective material 66 when necessary, such as during nighttime emergencies along the roadside or elsewhere.

The multi-threat base ensemble pants 14 further incorporate areas of breathable, stretchable material, such as knit material, that contribute to the utility and comfort of the pants 14 and the mobility of the wearer. The material can additionally or alternatively be selected or treated for fire resistance, moisture wicking, and antimicrobial characteristics. As seen in FIG. 6, for instance, the pants 14 incorporate a breathable, stretchable material as a yoke 72 that spans the posterior of the pants 14 just below the waistband 44. The yoke 72 has a generally straight upper edge and a V-shaped lower edge centered in the posterior of the pant 14. The yoke 72 so constructed provides flexibility to the wearer in bending and provides give in the seat of the pants 14. The pants 14 further incorporate an area 74 or panel 74 of breathable, moisture-wicking, stretchable material posterior to the knee to permit ventilation and comfort where the bend of the knee occurs and to facilitate softer folds as the wearer crouches or sits. The anterior knee panel 85 could, in certain embodiments, also be formed to include a breathable, stretchable material to provide further comfort and flexibility to the wearer. Still further, a diamond-shaped gusset 76 of breathable, flexible material is disposed in the crotch to provide breathability, moisture management, antimicrobial, comfort, and stretch capabilities in that region.

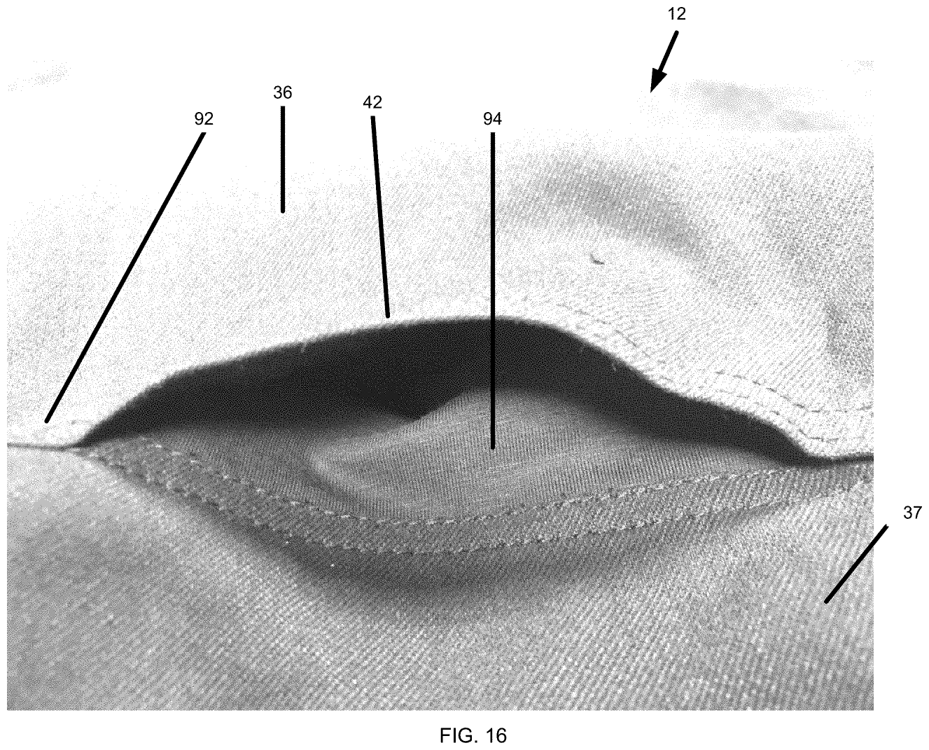

Selectively operable ventilation apertures in the form of selectively actuated openings are disposed in the anterior thigh portion of the pants 14. In an embodiment, the selectively-actuated openings are selectively opened and closed by zippers 78. The zippers 78 are disposed in a diagonal orientation across the thigh of the legs of the pants 14. The zippers 78 comprise concealed zippers, and the apertures created when the zippers 78 are selectively actuated to an open condition are backed with a more breathable material, such as a knit backing 96, as can be perceived in FIG. 13. The open condition of the zippers 78 locates the zipper slider at the upper end of the diagonally disposed opening. With that, the selectively-actuated openings can be quickly and conveniently opened for venting and zipped closed quickly in the downward direction as necessary, such as in response to arrival at an emergency scene. The knit backing 96 is higher in air permeability and moisture wicking than the material of the main body of the pants 14. However, the knit is sufficiently tightly constructed to prevent unwanted dirt and debris from entering the pants 14. The pants 14 can further incorporate an added layer of reinforced seat area 80 to provide further durability and strength in that high wear and high stress area to, among other things, prolong the life of the garment.

The knee portions of the pants 14 incorporate an anterior targeted hazard protection system at the knee (also referred to as a knee pad system) and a posterior knee cinching system. The knee cinching system and the knee pad system alone and in combination further adapt the multi-threat base ensemble pants 14 to effective and comfortable use by the wearer while providing enhanced threat protection. As can be envisioned by one of ordinary skill in the art, in some embodiments, the targeted hazard protection system could be located at the elbow of the base ensemble shirt 12. In such an embodiment, the cinching system would be located anteriorly and the targeted hazard protection system located anteriorly.

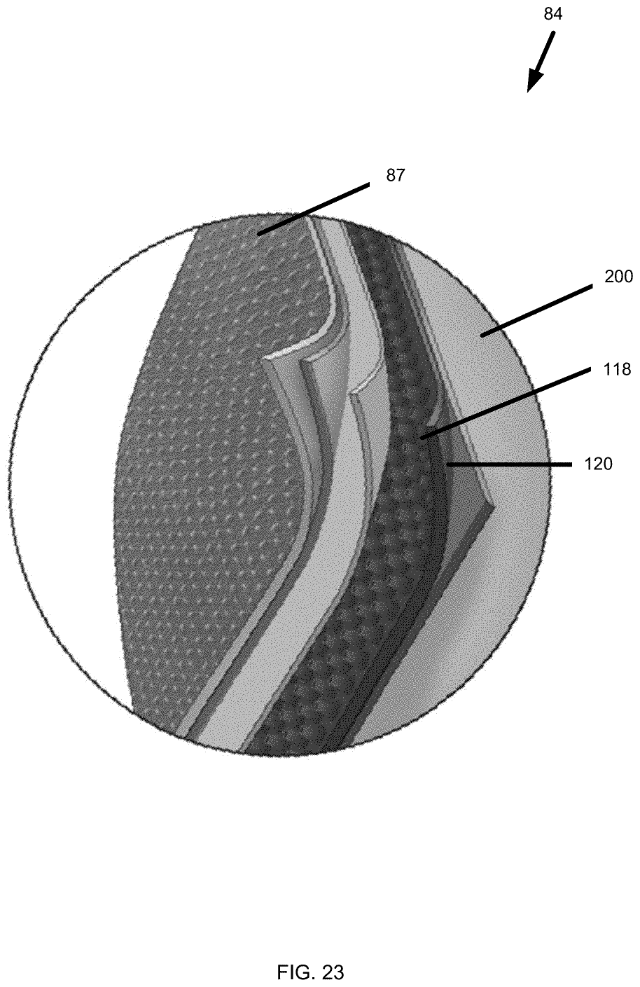

The targeted hazard protection system, referred to as the knee pad system in this particular embodiment, comprises a layered system of multiple components that synergistically combine to provide a high-functioning knee pad. Looking additionally to FIG. 13, the knee pad system is founded on a multi-layer anterior knee panel 85. The anterior knee panel 85 can have an outer layer of woven material with a layer of knit material thereunder. A liquid impervious, cut-resistant layer is disposed between the knit comfort layer and the woven outer layer. A cross-sectional illustration of an embodiment of the targeted hazard protection system is shown in FIG. 23. The knit material can provide comfort next to the skin of the wearer 200. The woven outer layer can comprise a Type 2 material as discussed herewithin. An additional external layer of shell material can be included to provide extra durability.

In some embodiments, a two-piece knee pad is fixed to the anterior knee panel 85. More particularly, the two-piece knee pad is formed by a contoured upper knee pad 82 and a contoured lower knee pad 84. The upper and lower knee pads 82 and 84 are marginally separated on the anterior knee panel 85 to permit flexibility and articulation. The contoured upper knee pad 82 can have an upper arcuate border and a lower border with a protuberating central valley. The contoured lower knee pad can have a negative upper valley, left and right wing portions, and a bulbous bottom portion. The upper knee pad 82 protects the kneecap, and the lower knee pad 84 protects the shin, such as when the first responder kneels.

In each knee pad 82 and 84, a liquid impervious membrane can be laminated between the outer layer of woven material and the layer of knit material. With that, the upper and lower knee pads 82 and 84 are themselves formed by plural layers of material with the liquid impervious membrane captured between the woven and knit layers. The liquid impervious membrane creates a liquid barrier while the inner layer of knit material provides comfort and flexibility and the outer layer of woven material adds durability.

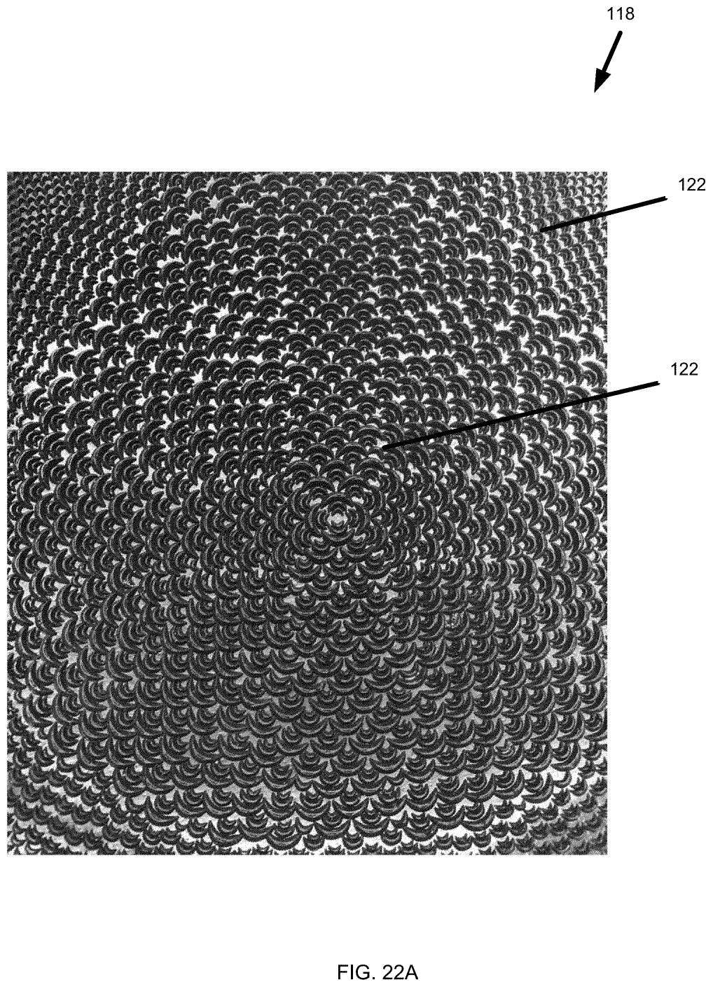

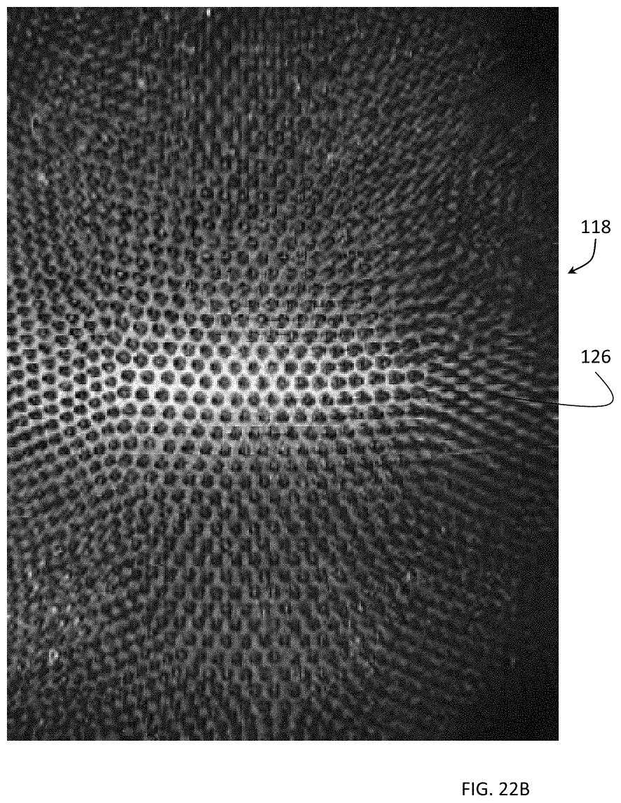

The knee pads 82 and 84 are of similar construction to one another. In certain embodiments, each has a layer forming the liquid impervious membrane. The layer could include or be formed from a polymeric material. The potential construction of liquid impervious membranes according to the present disclosure can be better understood with additional reference to FIGS. 21A through 22D. FIGS. 21A and 21B depict a stage in the formation of the liquid impervious membranes. An upper membrane 116, which forms the liquid impervious membrane for the upper knee pad 82, and a lower membrane 118, which forms the liquid impervious membrane for the lower knee pad 84, are disposed within a panel 120 prior to being separated, such as by cutting, stamping, or any other method, into individual upper and lower membranes 116 and 118. Each of the upper and lower membranes 116 and 118 has an inner surface and an outer surface. In various embodiments, panel 120 can be an engineered knit layer and can include or be formed from expanded polytetrafluoroethylene (ePTFE), polyurethane, or other thin breathable film layer.

As shown in relation to the lower membrane 118 in FIG. 22A, the outwardly facing surface of each membrane 116 and 118 can have a central pattern 122 and a peripheral pattern 124 that surrounds the central pattern 122. The central and peripheral patterns 122 and 124 are designed to provide enhanced abrasion resistance. To that end, the central pattern 122 is formed with an array of plural crescent-shaped protuberances 126 (or protuberating formations), such as crescent-shaped ridges. At least some of the crescent-shaped formations are disposed in groups. The formations vary in size. For instance, groups of crescent-shaped formations are in this example nested as crescent shaped protuberances of progressively increasing size, such as in groups of three or more. The groups of crescent-shaped formations generally emanate radially from a central location to a shape generally matching, but inwardly spaced from, the peripheral edge of the respective membrane 116 or 118. An array of differently-shaped protuberances, such as conical protuberances, is disposed in a peripheral pattern 124 to surround the array of the central pattern 122 between the central pattern 122 and the periphery of the respective membrane 116 or 118. The crescent shape can provide some extra durability to the overall structure of the knee pad.

As shown in relation to the lower membrane 118 in FIG. 22B, the inwardly facing surface of each membrane 116 and 118 has an array of protuberances 126 spaced thereover. The protuberances 126 are operative to provide shock absorbing characteristics built directly into the inner surfaces of the membranes 116 and 118. The shock absorption structuring is, in one example, formed by small open protuberating structures 126 that resemble volcanoes. The protuberances 126 can, for instance, have frusto-conical peripheral walls and open central portions. The volcano shape provides cushioning due to the flexibility of the volcano shapes when pressure is applied. The material is light and breathable. The protuberances 126 and the knee pads 82 and 84 in general thereby provide impact and shock absorption and, consequently, added comfort to the wearer with minimized impact on flexibility thereby further contributing to the ongoing wearability and durability of the base ensemble 10 and the continued performance of the wearer.

In embodiments, the protuberances 126 can be crescent shaped, frusto-conical shaped, or a combination thereof. The height of protuberances 126 can be from about 0.02 to 5 mm, or about 0.05 to 3 mm, and the diameter or widest portion can be from about 0.01 mm to 1 mm, or about 0.3 to 1 mm.

In embodiments, the rubberized layers of the upper and lower membranes 116 and 118 are formed from a cut-resistant material with the arrays of protuberances 126 as shown and described to perform the dual functions of abrasion resistance and shock absorption. Proprietary methods of microembossing patterns are employed in the technical design of the material. Specialized polymer formulations are utilized to provide specific characteristics e.g. flame resistance, grip, and coloration.

The knee pads 82 and 84 can further include a layer of shell material 87 that is printed with a capsule-shaped print as shown, for instance, in FIG. 13. The layer of shell material 87 can, in one example, comprise a three-dimensional printed polymer providing abrasion resistance, such as that sold under the registered trademark SUPERFABRIC®. Despite the protections provided, the knee pads 82 and 84 can be crafted to be thinner in final construction with impact attenuation protection while remaining substantially as flexible as a textile material.

The anterior knee pad system in certain embodiments provides at least an average rating force of 1000 gf higher than the base pant fabric (ASTM F1790-97 and ANSI/ISEA 105-2011). Also in certain embodiments, the anterior knee pad system attenuates at least 50% of the force with 544 gram weight at 0.5 m height above that of the base pant material with a thickness no higher than 4.0 mm.

The two-pieced, multi-layer knee pad so formed by the upper and lower knee pads 82 and 84 can be stitched and cover stitched onto the anterior knee panel 85. The materials for the knee pad system formed by the upper and lower knee pads 82 and 84 is fire resistant with no melt characteristics. The knee pad system is also designed to avoid presenting a stored energy threat, meaning that it is designed not to hold heat. Accordingly, where the wearer is exposed to a thermal threat and then compresses the knee, such as by kneeling, no injury will be caused from heat transfer. For instance, the stored energy protection for the composite is designed so that burning of the wearer is minimized or eliminated even after sixty seconds using the stored energy test procedures as a composite. By the incorporation of an abrasion resistant coating, patch, or layer, the overall life of the knee pads 82 and 84 is improved by protecting the pad itself from direct contact with hazardous elements. The disclosed pad structure could alternatively be constructed for use as an elbow pad structure.

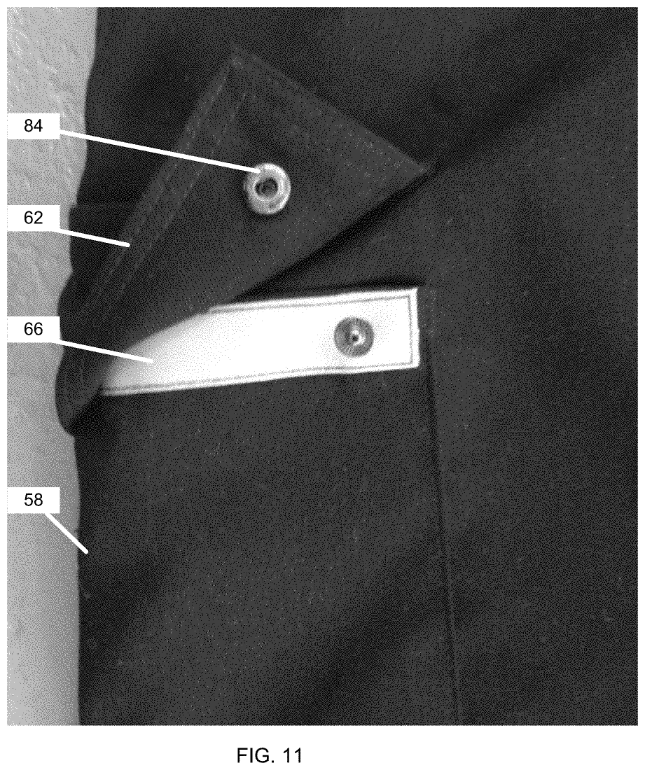

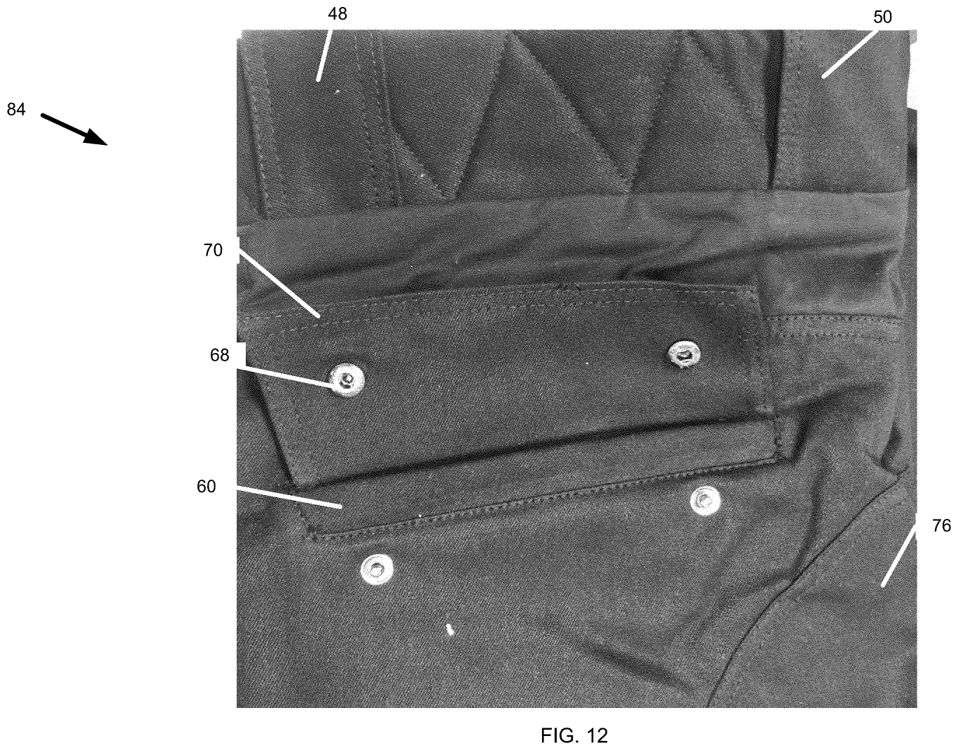

The posterior knee cinching system permits the knee portions of the multi-threat base ensemble pants 14 to be selectively cinched about the knees of the first responder and to be selectively loosened about the knees of the first responder. Looking, for example, to FIGS. 6 through 9, the knee cinching system is formed with an elastic cord 86 that travels to form a continuous loop through sleeves 88. The sleeves 88, and thus the elastic cord 86, surround an area 74 including the area posterior to the knee. Segments of the cord 86 are exposed by gaps between the sleeves 88, including to left and right sides of the knee. Left and right hooks 90 are retained in opposition to one another and in opposition to gaps between the sleeves 88 to left and right sides of the knee.

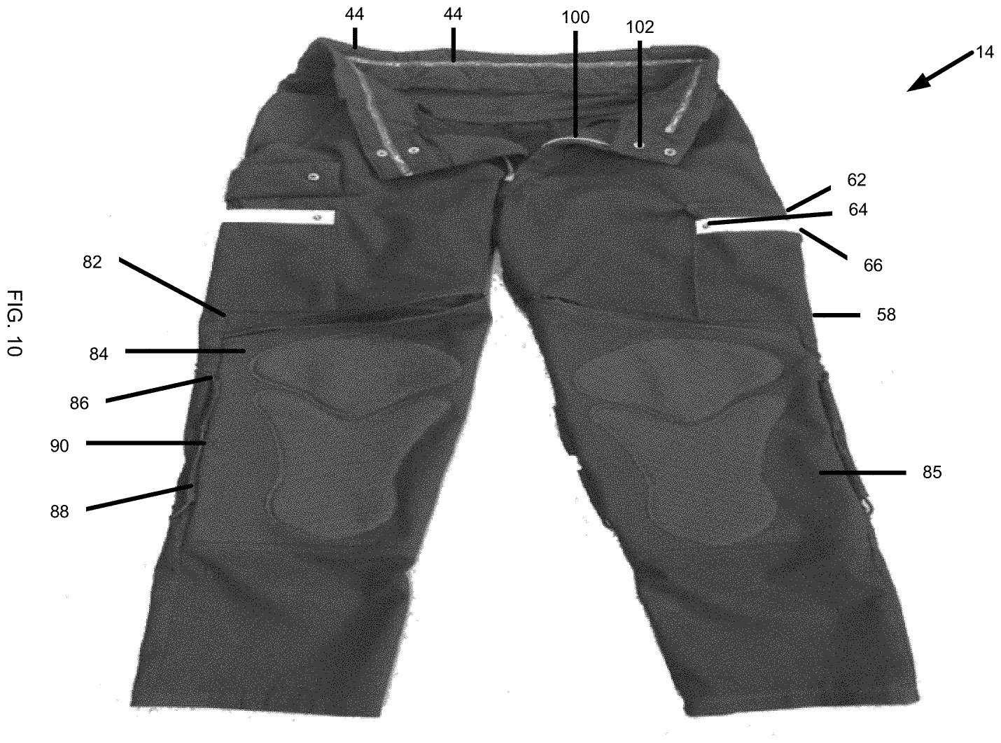

Under this construction and as is shown in FIG. 7, the exposed segment of the cord 86 to the left side of the knee can be pulled toward the right side of the knee to be retained by the hook 90 on that side, and the exposed segment of the cord 86 to the right side of the knee can be pulled toward the left side of the knee to be retained by the hook 90 on that side. The cord 86 is thus pulled to and maintained in a crossed over, cinched configuration. The entire knee areas of the pants 14 can thus be cinched to achieve a snug configuration about the first responder's knees while tending to maintain the upper and lower knee pads 82 and 84 in ideal position for optimal multi-threat protection in emergency conditions. The knee cinching system permits the knee pads 82 and 84 to be drawn close to the knee and to be adjusted as needed, such as for different sizes, fits, or during functional tasks to keep the pads closer to the knee and increasing the impact protection capabilities. In other embodiments, the cinching system can be located adjacent to another targeted hazard protection system, such as at an elbow, to selectively draw the

The fabric materials for the multi-threat base ensemble 10 can include fire resistant knit and fire-resistant woven materials. By way of example and not limitation, flame resistant base layering as sold under the registered trademark MASSIF® knit can be employed, and materials sold under the registered trademark TENCATE® can be used for woven materials. Fabric components of the shirt 12 can, for instance, be woven, fire resistant fabric as sold under the trademark TECASAFE® 580A, which is a 5.8 oz material. Fabric components of the pants 14 can, for instance, be of similar material but of a heavier weight, such as the fire-resistant woven fabric sold under the trademark TECASAFE® 700A, which is a 7 oz material.

The threat protection of the base ensemble 10 is, in particular embodiments, further improved by wet padding the fabrics, including the laminate portions of the woven materials, with antimicrobial treatment and water and oil repellents, such as durable omniphobic repellent. The finish treatments can be padded on together. The antimicrobial treatment could, for instance, be that sold under the trademark ULTRAFRESH™ while the durable omniphobic repellent could be that sold by Ultra Tech Brands under the trademark EVERSHIELD™. Such a combination of finishes creates an improved threat barrier as it possesses the capability to repel liquids, including certain oils (rated at 6 per AATCC 118 method, Oil Repellency-Hydrocarbon Resistance Test), rain, and bodily fluids. This not only keeps the wearer dry and comfortable in inclement weather but also repels blood, urine, and vomit as is highly desirable from a number of viewpoints, including health and safety. In the event the multi-threat base ensemble 10 becomes soiled, the antimicrobial finish provides further benefits to the wearer to assist in lowering exposure to undesired liquids. Additional benefits of the antimicrobial treatment include odor reduction, such as from sweat produced by a wearer, thereby reducing the need for frequent laundering and potentially increasing the longevity of the multi-threat base ensemble 10. Embodiments of the multi-threat base ensemble 10 can incorporate a cut material, such as fiberglass engineered fabric, that provides a composite protection of ANSI/ISE 105-2011 (sec 5.1.1) Cut Level 4 (minimum of 1,500 grams in ASTM F 1790 test method). As taught herein, the multi-threat base ensemble 10 selectively incorporates a membrane technology to provide either impermeable or permeable barrier protection to bloodborne pathogens and, additionally or alternatively, chemical hazards.

The multi-threat base ensemble 10 can be manufactured to meet Underwriters Laboratories NFPA 1975 standard, which is the 2014 Edition Standard on Emergency Services Work Clothing Elements. The Standard's scope is to specify requirements for the design, performance, testing, and certification of non-primary protective work apparel and the individual garments comprising work apparel. The NFPA standard also specifies requirements for the thermal stability of textiles used in the construction of work apparel. Testing encompasses design requirements and performance requirements. The base ensemble 10 can be manufactured to be free of rough spots and sharp edges, and contact of metal with the wearer's body can be avoided. The base ensemble 10 can provide thermal stability, seam strength, and product label printing durability. Compliance with the NFPA 1975 standard provides emergency services personnel with work apparel that will not contribute to burn injury severity while providing even further threat protection. By complying with the standard, assurance can be had that, among other things, the textiles employed are thermally stable and will not rapidly deteriorate, melt, shrink, or adhere to the wearer's skin, causing greater, more severe burn injuries. Meanwhile, the base ensemble 10 is compatible with other primary Personal Protective Equipment. The base ensemble 10 is modular and can be worn under and with an array of Personal Protective Equipment from all communities. Particularly advantageous to emergency medical technicians, the base ensemble can provide splash resistance, such as to biological contaminants, and the impact resistant knee pad system increases protection in medical emergency situations where a person in need is tended to by the responder.

Fundamentally for all types of personnel, including correctional guards, private security forces, and first responders, such as firefighters, emergency medical personnel, and law enforcement, the base ensemble 10 can act as a comfortable, daily wear base uniform system designed to provide functional protection from multiple daily hazards. As used herein, “functional protection” is defined as placing protection technologies in areas on the base ensemble 10 with the highest or higher than normal likelihood of hazard contact while permitting other areas of the base ensemble 10 to enjoy flexibility and low material burdens to minimize the overall impact on overall garment comfort. Protection aspects of the base ensemble 10, including impact resistance, cut resistance, fire resistance, antimicrobial properties, and durable omniphobic repellence, are strategically placed within the shirt 12 and pants 14 so that comfort and functionality was optimized while the base level of protection was enhanced. By way of example and not limitation, the placement of membrane material in the knee area where the likelihood is high that a user will need higher protection from liquid penetration through compression, such as by kneeling on blood contamination, while not providing such membrane material in other locations permits the base ensemble 10 to be wearable with a balance between adequate protection and avoiding significant impacts on thermal comfort and flexibility. The concept of functional protection is likewise carried forth in relation to the cut protection provided by the knee pad materials and knee pads that are light in weight while providing for impact protection.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

A modified system engineering approach was used during development of the base ensemble described herein. This approach included rigorous needs analysis and specification development to ensure traceability of user needs throughout. Data-driven multi-criteria decision-making methods were used during material and design selection to optimize ensemble performance. Fabric and ensemble level testing occurred in research and testing facilities that enabled systematic testing and evaluation of the developed prototype. Performance assessments included Heat Storage, Heat and Thermal Shrinkage, Thermal Stability and Vertical Flame tests for fire and heat protection, repellency and splash protective tests as well as fabric and system-level evaluation of thermal comfort. Human subject ergonomic and subjective comfort evaluations were also performed, which informed further development and optimization.

The base ensemble described herein integrates state-of-the-art protective technologies including flame resistance, blood-borne pathogen splash protection, water repellency, optimal daily-wear comfort, integrated kneepads, localized cut and impact protection and deployable reflectivity among other features. The base ensemble is certified to the requirements of the National Fire Protection Association's (NFPA) 1975 Standard on Emergency Services Work Clothing Elements (2014 edition). One hundred fifty (150) certified prototypes were delivered to the Department of Homeland Security for extended operational wear testing.

Over 50 materials were sourced and tested for the base ensemble. In a preferred embodiment, a combination of commercially available materials were selected (Table 1). Additional treatments were applied to the materials before assembly of the base ensemble to provide the materials with desired characteristics (Table 2) at specific areas of the base ensemble. For example, antimicrobial treatment, durable omniphobic repellants, and combinations thereof were applied to the fabrics, depending on the fabric's location on the base ensemble.

TABLE 1
Commercially available fabrics selected for base ensemble.

| Manufacturer | Style ID | Fiber Content | Construction |
|---|---|---|---|
| TenCate ® | 580A | Modacrylic, Cellulose, Aramid | Woven |
| TenCate ® | 700A | Modacrylic, Cellulose, Aramid | Woven |
| Massif ® | Blaze | 93% Cotton, 7% Spandex | Knit |
| Agrotec | TX4100 | Polyurethane | Film |

TABLE 2
Materials Selected for use in NFPA 1975
certified base ensemble prototypes

| | | | | Key |
|---|---|---|---|---|
| Material | Material | Treatments | Material | Performance |
| Type | Names | Applied | Location | Attributes |
| Type 1 | TenCate | Antimicrobial, | Shirt | Optimized FR*, |
| | TecaSafe ® | DOR*, | | Cost, |
| | 580A | | | & Comfort |
| Type 1 | TenCate | Antimicrobial, | Pant | Optimized FR*, |
| | TecaSafe ® | DOR*, | | durably treatable |
| | 700A | | | for AM* |
| | | | | & DOR*, |
| | | | | cost & comfort |
| Type 2 | Massif Blaze | None | Shirt back | Stretch and |
| | | | vent, | recovery, |
| | | | leg vent, | moisture wicking, |
| | | | back of | FR*, & pass |
| | | | knee, | thermal |
| | | | crotch | stability |
| | | | gusset, | & shrinkage |
| | | | back yoke | |
| Type 3 | TenCate | DOR* | Pant knee | Best combination |
| | TecaSafe ® | | | of liquid |
| | 700A/TX4100/ | | | protection & |
| | Massif Blaze | | | flexibility |

*FR = Flame Retardant, AM = Antimicrobial, DOR = Durable Omniphobic Repellent

The Type 1 materials selected were generally Flame Resistant (FR), available in a Navy color, and within the 5-8.0 oz/yd2 weight range. Type 1 materials, having flame retardant properties, were additionally treated with an antimicrobial and a durable omniphobic repellant. These materials can be used to form the main portions of the shirt 12 and pants 14, including but not limited to the front portion 16, arms 15, rear portion 18, front placket 20, shoulder yoke 35, chest pocket 38, waist pocket 54, coin pocket 56, cargo pocket 58, rear pocket 60, etc.

Similarly, the Type 2 materials were generally Flame Resistant, highly air permeable, moisture wicking, available in a Navy color, and within the 5-7.0 oz/yd2 weight range. Type 2 material possesses moisture wicking and flame-retardant properties and were used in areas where stretch and ventilation are desirable (including but not limited to the shoulder panel 36, side panel 40, selectively actuated openings 79, yoke 72, panel 74, and crotch gusset 76).

Type 3 materials were formed from a tri-laminate fabric designed specifically for the base ensemble using a combination of woven, knit and membrane technologies shown in Table 1 because no commercially available laminate materials were found that were thin and comfortable and yet still provided some chemical protection. The Type 3 materials are composites including Type 1 and Type 2 materials treated with a durable omniphobic repellant. The material treatments and combinations of materials were selected to impart desired characteristics without sacrificing the individual advantages of the individual materials. Therefore, the materials (membrane/laminate) were combined based on their ability to pass the liquid, water and viral penetration tests from NFPA 1971, their ability to be flexible as a laminate, their Moisture Vapor Transmission Rate (MVTR), and their oil resistance. Type 3 materials were used for the multi-layer anterior knee panel 85.

In various embodiments, the durable omniphobic repellant can have a viscosity of about 4-5 cP and a pH of approximately 6.5 (diluted measurements). In various embodiments, the durable omniphobic repellant can include a polymer (about 5-10% by volume), Dihydroxylpropyl PEG-5 Linoleammonium Chloride (about 1-5%), [(Methylethylene)bis(oxy)]dipropanol (about 1-5%) and silicone dioxide (1-5%) in an aqueous solution. In various embodiments, the durable omniphobic repellant can be EverShield™.

In various embodiments, the antimicrobial treatment can include Bis(1-hyroxy-2(1H)-pyridinethionato-O,S)-(T-4) zinc (about 30-50% by volume), Sodium polynaphthalene sulfonate (about 1-10% by volume), and water.

The treatments for the materials were applied using wet processing and/or pad dipping and/or pad dry cure. In an embodiment, the fabric reached 160 C for 30-60 seconds to cure after pad dipping.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

What is claimed is:

1. A multi-threat base ensemble comprising:
a base ensemble shirt; and
base ensemble pants;
where the base ensemble shirt and the base ensemble pants comprise materials providing flame and chemical protection to a wearer;
where the base ensemble shirt and the base ensemble pants further comprise:
a targeted hazard protection system providing protection to the wearer at predetermined areas of the base ensemble shirt or the base ensemble pants;
where the targeted hazard protection system is multi-layered, comprising upper and lower pads between a knit layer and a woven layer, the upper and lower pads comprising a liquid impervious membrane and protuberances disposed on the liquid impervious membrane;
a cinching system for selectively adjusting a portion of the base ensemble shirt or the base ensemble pants between a cinched condition and a non-cinched condition, where the portion of the base ensemble shirt or the base ensemble pants is adjacent to the targeted hazard protection system allowing the targeted hazard protection system to be selectively drawn into proximity with a body of the wearer; and
areas of stretchable ventilation incorporated within the base ensemble shirt and the base
ensemble pants to provide air ventilation within the base ensemble shirt and the base ensemble pants; and
selectively-actuated ventilation openings.

2. The multi-threat base ensemble of claim 1, wherein the protection comprises liquid impermeability, cut protection, impact protection, chemical protection, and heat protection.

3. The multi-threat base ensemble of claim 1, wherein the protuberances are crescent shaped, are frusto-conical shaped having open central portions, or a combination thereof.

4. The multi-threat base ensemble of claim 1, wherein at least one portion of the base ensemble shirt or the base ensemble pants has been treated with an antimicrobial treatment, a durable omniphobic repellent, or a combination thereof.

5. The advanced multi-threat base ensemble of claim 1, further comprising a material having a high coefficient of friction disposed on a waistband portion of the base ensemble shirt or the base ensemble pants.

6. The multi-threat base ensemble of claim 1, further comprising a selectively deployed reflective surface.

7. The multi-threat base ensemble of claim 6, wherein the selectively deployed reflective surface is affixed to at least one of a pocket, a collar, or a cuff of the multi-threat base ensemble.

8. A multi-threat base ensemble comprising:
a base ensemble shirt; and
base ensemble pants;
where the base ensemble shirt and the base ensemble pants comprise materials providing flame and chemical protection to a wearer;
where at least one portion of the base ensemble shirt or the base ensemble pants has been treated with an antimicrobial treatment, a durable omniphobic repellent, or a combination thereof;
a targeted hazard protection system providing liquid impermeability, cut protection, impact protection, chemical protection, and heat protection to the wearer at predetermined areas of the base ensemble shirt or the base ensemble pants;
where the targeted hazard protection system is multi-layered, comprising upper and lower pads between a knit layer and a woven layer, the upper and lower pads comprising a liquid impervious membrane and protuberances disposed on the liquid impervious membrane;
a cinching system for selectively adjusting a portion of the base ensemble shirt or the base ensemble pants between a cinched condition and a non-cinched condition, where the portion of the base ensemble shirt or the base ensemble pants is adjacent to the targeted hazard protection system allowing the targeted hazard protection system to be selectively drawn into proximity with a body of the wearer; and
areas of stretchable ventilation incorporated within the base ensemble shirt and the base ensemble pants to provide air ventilation within the base ensemble shirt and the base ensemble pants; and
selectively-actuated ventilation openings.

9. A multi-threat base ensemble comprising:
base ensemble pants comprising materials providing flame and chemical protection to a wearer;
where the base ensemble pants further comprise:
a targeted hazard protection system providing protection to the wearer at the anterior knee area of the base ensemble pants;
where the targeted hazard protection system is multi-layered, comprising upper and lower pads between a knit layer and a woven layer, the upper and lower pads comprising a liquid impervious membrane and protuberances disposed on the liquid impervious membrane;
a cinching system for selectively adjusting a portion of the base ensemble shirt or the base ensemble pants between a cinched condition and a non-cinched condition, is located at the posterior knee area, allowing the targeted hazard protection system to be selectively drawn into proximity with a body of the wearer; and
areas of stretchable ventilation incorporated within the base ensemble pants to provide air ventilation; and
selectively-actuated ventilation openings.

10. The multi-threat base ensemble of claim 9, further comprising a base ensemble shirt wherein the base ensemble shirt comprises materials providing flame and chemical protection to a wearer;
areas of stretchable ventilation incorporated within the base ensemble pants to provide air ventilation; and
selectively-actuated ventilation openings.

11. The multi-threat base ensemble of claim 10, further comprising a targeted hazard protection system providing protection to the wearer at the posterior elbow area;
where the targeted hazard protection system is multi-layered, comprising upper and lower pads between a knit layer and a woven layer, the upper and lower pads comprising a liquid impervious membrane and protuberances disposed on the liquid impervious membrane; and
a cinching system for selectively adjusting a portion of the base ensemble shirt between a cinched condition and a non-cinched condition, where the portion of the base ensemble shirt is located at the anterior elbow area, allowing the targeted hazard protection system to be selectively drawn into proximity with a body of the wearer.
